(19) United States
(12) Patent Application Publication
(10) Pub. No.: US 2026/0136444 A1
(43) Pub. Date: May 14, 2026

(54) LIGHTING DEVICE CAPABLE OF MONITORING LIGHTING QUALITY THEREOF

(71) Applicant: SAVANT TECHNOLOGIES LLC, East Cleveland, OH (US)

(72) Inventors: Shengyou SUN, Shanghai (CN); Kun XIAO, Shanghai (CN); Zhiqiang SHI, Shanghai (CN)

(73) Assignee: SAVANT TECHNOLOGIES LLC, East Cleveland, OH (US)

(21) Appl. No.: 19/358,757

(22) Filed: Oct. 15, 2025

(30) Foreign Application Priority Data
Oct. 31, 2024 (CN) 2024226544716

(51) Int. Cl. H05B 45/58; H05B 45/34

(52) U.S. Cl. CPC H05B 45/58; H05B 45/34

(57) ABSTRACT

Provided is a lighting device that includes a lighting diode, connected to an external power source by a driver to receive electric energy and emit light, a sampling and control unit, connected in parallel with the lighting diode, to sample the voltage of the lighting diode or a specific device in a circuit when the lighting diode receives electric energy and emits light, and an indicator diode, located on a parallel branch where the sampling and control unit is located, the sampling and control unit compares the sampled voltage with a preset value, and when the sampled voltage is greater than or varies from the preset value, the sampling and control unit sends a control signal, and the control signal controls the light-emitting state of the indicator diode to change, or controls the light-emitting state of the lighting diode to change where the indicator diode is not needed.

### CROSS-REFERENCE TO RELATED APPLICATIONS

This application claims priority to Chinese Patent Application Serial Number 2024226544716, filed Oct. 31, 2024, which is herein incorporated by reference.

### TECHNICAL FIELD

The present disclosure relates to the field of lighting, and in particular to a lighting device capable of monitoring the lighting quality thereof.

### BACKGROUND

Generally, the rated lifespan of lighting devices (or LED lamps) is between 10,000 hours and 50,000 hours. At the end of life, the lighting device has a safety risk. First, the lumen (representing the total amount of light emitted by a light source) drops significantly; and second, the lighting device may cause smoke or fire.

In order to solve the safety risk of the lighting device at the end of life, the present application proposes a lighting device capable of monitoring the lighting quality thereof. Regarding the lighting device, when it is determined that the voltage of a lighting diode increases above a preset value, a circuit state of an indicator is controlled to change or a light-emitting state of the lighting diode is directly controlled to change, such that a user performs operations, such as detection, maintenance, or replacement, etc. on the lighting device with an increased voltage, so as to avoid potential safety risks of the lighting device, avoid eye fatigue of the user, and improve the sales volume of the lighting device.

By means of the described design, the lighting device of the present application can effectively indicate the lighting quality condition of the lighting device to a user, and help the user to take measures in time.

### SUMMARY OF THE INVENTION

In view of this, the present disclosure is intended to provide an improved lighting device. The lighting device can sense, by a microcontroller unit or a sensing element, that the voltage of a lighting diode increases above a preset value, and in this case, the circuit state of an indicator diode is controlled to change, or the light-emitting state of the lighting diode is controlled to change without the need of the indicator diode, thereby effectively indicating the lighting quality condition of the lighting device to a user, so as to avoid potential safety risks of the lighting device, avoid eye fatigue of the user, and improve the sales volume of the lighting device.

According to one aspect of the present disclosure, provided is a lighting device capable of monitoring the lighting quality thereof, the lighting device comprising: a lighting diode, connected to an external power source by a driver to receive electric energy from the external power source and emit light; a sampling and control unit, connected to the lighting diode, the sampling and control unit comprising: a sampling end for sampling the voltage of a specific device in a circuit when the lighting diode receives electric energy and emits light, and an output end for making a determination according to the sampled voltage and sending a control signal; and an indicator diode, located on a branch where the sampling and control unit is located, and used for receiving the control signal; wherein when a comparison result between the sampled voltage and a preset value changes, the output end of the sampling and control unit sends a control signal to the indicator diode, and the control signal controls the circuit state of the indicator diode to change.

In this way, the present disclosure can monitor the voltage of the lighting diode of which the voltage increases as the lighting duration increases, and when the voltage is greater than the preset value, the indicator diode is used as an indicator to indicate that the lighting diode should be subjected to operations such as detection, maintenance or replacement; or in cases where the indicator diode is not needed, the light-emitting state of the lighting diode can be controlled directly by the driver, so as to prompt that the lighting diode should be subjected to operations such as detection, maintenance or replacement. Thus, the present disclosure can avoid potential safety risks of the lighting device in a visual and simple way, avoid eye fatigue of the user, and improve the sales volume of the lighting device.

According to exemplary embodiments of the present disclosure, the circuit state of the indicator diode can be changed from an on state to an off state, or from an off state to an on state.

In this way, by the on or off of the indicator diode as an indicator, the user is intuitively and explicitly alerted that the lighting quality of the lighting diode deteriorates, or that the lighting diode is about to reach a rated lighting duration.

According to exemplary embodiments of the present disclosure, the sampling and control unit is a sensing element, which senses in real time the voltage of the lighting diode; and when a comparison result between the sampled voltage and the preset value changes, the sampling and control unit controls, via the control signal, the circuit state of the indicator diode to change.

In this way, the present disclosure can sense a voltage in real time using a sensing element, the sensing element can determine a magnitude relationship between the voltage and the preset value in real time, and control the circuit of the indicator diode to be turned on or off.

According to exemplary embodiments of the present disclosure, the sampling and control unit is a microcontroller unit, which samples the voltage of the lighting diode at a predetermined sampling frequency; and when the comparison result between the sampled voltage and the preset value changes, the sampling and control unit controls the circuit state of the indicator diode to change.

In this way, the present disclosure can sample the voltage of the lighting diode at a predetermined frequency, and the microcontroller unit determines the magnitude relationship between the voltage and the preset value at the predetermined frequency, and thus the circuit of the indicator diode is turned on or off.

According to exemplary embodiments of the present disclosure, the lighting device further comprises a voltage regulation device connected between the lighting diode and the ground; wherein when the lighting duration of the lighting diode reaches a rated lifespan duration, the voltage of the voltage regulation device changes.

According to exemplary embodiments of the present disclosure, the voltage regulation device comprises a first diode connected between the lighting diode and the ground, and a second diode connected in parallel with the first diode; wherein the first diode has a first forward voltage drop, and the second diode has a second forward voltage drop less than the first forward voltage drop; and when the turn-on duration of the second diode reaches the rated lighting duration of the lighting diode and the second diode is turned off, the voltage across two ends of the first diode increases.

In this way, in the present disclosure, two diodes are connected between the lighting diode and the ground, and the two diodes have different forward voltage drops. When the turn-on duration of the second diode reaches the rated lighting duration of the lighting diode and the second diode is automatically turned off, the voltage of the first diode increases; and after the voltage of the first diode increases, the sampling and control unit can acquire a more significant voltage, thereby more accurately determining the degradation of the lighting quality of the lighting diode, and indicating to the user that the lighting diode has reached the rated lighting duration.

According to exemplary embodiments of the present disclosure, the voltage regulation device is a resistor.

In this way, after the lighting diode is illuminated for a long time, the resistor in the present disclosure starts to generate heat and the resistance value thereof increases, such that the voltage across two ends of the resistor increases, and the sampling and control unit can acquire a more significant voltage, thereby more accurately determining the degradation of the lighting quality of the lighting diode, and indicating to the user that the lighting diode has reached the rated lighting duration.

According to exemplary embodiments of the present disclosure, the first diode is a silicon tube, and the second diode is a germanium tube.

According to exemplary embodiments of the present disclosure, the lighting device further comprises a bridge rectifier connected between the external power source and the lighting diode, the bridge rectifier rectifying an alternating current of the external power source to a direct current.

According to exemplary embodiments of the present disclosure, the lighting device further comprises a lighting diode driver connected between a positive electrode of the external power source and a positive electrode of the lighting diode; and the lighting diode driver converts electric energy from the external power source, such that the current flowing through the lighting diode is constant.

In this way, the lighting diode driver can effectively control the operating current of the lighting diode, and can provide a stable current output, thereby avoiding the occurrence of unstable operation or damage to the lamp due to voltage fluctuations or other external factors.

According to exemplary embodiments of the present disclosure, when the sampling and control unit is a microcontroller unit, the lighting device further comprises a microcontroller unit driver connected between the positive electrode of the external power source and the microcontroller unit, and the microcontroller unit driver converts a voltage from the external power source to drive the microcontroller unit.

In this way, the microcontroller unit driver can convert the voltage from the external power source into a voltage suitable for the microcontroller unit, thereby satisfying the requirements of the microcontroller unit.

According to exemplary embodiments of the present disclosure, the sampling and control unit comprises a voltage comparator, which is connected to the sampling end and the output end; wherein the voltage comparator compares the sampled voltage with the preset value and outputs a comparison result from the output end.

According to exemplary embodiments of the present disclosure, the lighting diode comprises a red diode emitting red light, a green diode emitting green light, or a blue diode emitting blue light.

In this way, the lighting diode can emit light of various colors, such as red, green and blue, and can mix light of different colors according to requirements, thereby realizing a rich and colorful lighting effect.

According to exemplary embodiments of the present disclosure, the preset value is a value input from the outside or an initial value sampled by the sampling and control unit.

According to exemplary embodiments of the present disclosure, the lighting device further comprises a current-limiting resistor connected in series with the sensing element to limit the current flowing through the sensing element so as to protect the sensing element.

In this way, the purpose of the current-limiting resistor is to limit the current flowing through the sensing element, so as to prevent the sensing element from being damaged due to overload. The resistance value of the current-limiting resistor can be selected according to the rated current and operating voltage of the sensing element, so as to ensure that the sensing element will not be overloaded under normal operating conditions.

According to exemplary embodiments of the present disclosure, the lighting device also comprises voltage-dividing resistors, which are connected in parallel with the sensing element, so as to provide a suitable sampled voltage to the sampling and control unit.

In this way, the voltage-dividing resistors are usually each designed as a resistor with a fixed resistance value, and the purpose thereof is to convert the voltage of the lighting diode into a voltage within a safety range acceptable by the sensing element. In this way, the sensing element can be effectively protected from being damaged by an excessive voltage, and malfunction of the sampling and control unit can also be prevented.

According to exemplary embodiments of the present disclosure, the sensing element is a TL431 element or a similar AZ431 element.

According to another aspect of the present disclosure, provided is a lighting device capable of monitoring the lighting quality thereof, the lighting device comprising: a lighting diode, connected to an external power source by a driver to receive electric energy from the external power source and emit light; and a sampling and control unit, connected to the lighting diode, the sampling and control unit comprising: a sampling end for sampling the voltage of a specific device in a circuit when the lighting diode receives electric energy and emits light, and an output end for making a determination according to the sampled voltage and sending a control signal; wherein when a comparison result between the sampled voltage and a preset value changes, the output end of the sampling and control unit sends a control signal to the driver, and the driver changes the light-emitting state of the lighting diode according to the control signal.

In this way, in cases where an indicator is not needed, the present disclosure can allow for visually learning the deterioration of the lighting quality of the lighting diode at a low cost by directly controlling the flickering or darkening of the lighting diode by the driver.

According to exemplary embodiments of the present disclosure, the sampling and control unit is a sensing element, which senses in real time the voltage of the lighting diode; and when a comparison result between the sampled voltage and the preset value changes, the sampling and control unit controls, via the control signal, the light-emitting state of the lighting diode to change.

According to exemplary embodiments of the present disclosure, the sampling and control unit is a microcontroller unit, which samples the voltage of the lighting diode at a predetermined sampling frequency; and when a comparison result between the sampled voltage and the preset value changes, the sampling and control unit controls, via the control signal, the light-emitting state of the lighting diode to change.

According to exemplary embodiments of the present disclosure, the lighting device further comprises a voltage regulation device connected between the lighting diode and the ground; wherein when the lighting duration of the lighting diode reaches a rated lifespan duration, the voltage of the voltage regulation device changes.

According to exemplary embodiments of the present disclosure, the sampling and control unit comprises a voltage comparator; wherein the voltage comparator is connected to the sampling end and the output end; wherein the voltage comparator compares the sampled voltage with the preset value and outputs a comparison result from the output end.

According to exemplary embodiments of the present disclosure, the light-emitting state of the lighting diode changes to be flickering or darkening.

In embodiments of the present disclosure, technical solutions in which the sampling and control unit controls the circuit state of the indicator, or directly controls the light-emitting state of the lighting diode by determining a comparison between the sampled voltage of the lighting diode and the preset value are provided, so as to at least solve the technical problems of deteriorated lighting quality, potential safety risks, and poor user experience in the prior art, and achieve the technical effects of avoiding potential safety risks of the lighting device, avoiding the eye fatigue of the user, and improving the sales volume of the lighting device.

### BRIEF DESCRIPTION OF THE DRAWINGS

The drawings illustrated herein are used for providing further understanding of the present utility model, constitute a part of the present application; and illustrative embodiments of the present application and illustrations thereof are used for explaining the present application, rather than constitute inappropriate limitations on the present application. In the drawings:

FIG. 1 is a schematic diagram showing the use of a sensing element to control an indicator diode.

FIG. 2 is a schematic diagram showing the use of a microcontroller unit to control an indicator diode.

FIG. 3 is a schematic diagram showing the use of two diodes as a voltage regulation device.

FIG. 4 is a schematic diagram showing the use of a resistor as a voltage regulation device.

FIG. 5 is a schematic diagram in which in cases where an indicator diode is not needed, a microcontroller unit sends a control signal to a lighting diode driver to directly control a lighting diode via the lighting diode driver.

FIG. 6 is a schematic diagram showing the structure of a lighting diode and an indicator diode in a bulb.

### DETAILED DESCRIPTION

Hereinafter, embodiments of the present application will be described in detail with reference to the accompanying drawings, such that a person skilled in the art could easily implement the embodiments of the present application. The present application may, however, be embodied in many different forms, and should not be construed as limited to the embodiments set forth herein. In the drawings, parts irrelevant to the illustration of the present application will be omitted for clarity. Similar reference numerals refer to similar elements throughout the illustration. In addition, when the illustration with reference to the drawings is provided, although elements are denoted by the same numeral, the reference numerals involving the elements may be changed; and the reference numerals are illustrated only for convenience of illustration, and should not be understood as limiting the concept, features, functions, or effects of the elements.

In practical applications, when the accumulated lighting duration of a lighting device (or LED lamp) is greater than a rated lighting lifespan, not only the lumen drops, but also safety hazards such as smoke or fire may occur, and insufficient brightness may cause eye fatigue of a user.

Therefore, it is crucial to determine whether the lighting quality of the lighting device deteriorates, whether there is a potential safety problem, or the like.

To this end, the present disclosure provides a lighting device capable of monitoring the lighting quality thereof. By determining whether the voltage of a lighting diode is greater than a preset value, the lighting device controls an indicator diode to perform indication, or directly controls, by a driver, the lighting diode to flicker or darken without the need of the indicator diode, thereby facilitating a user in checking, repairing or replacing the lighting device according to the indication.

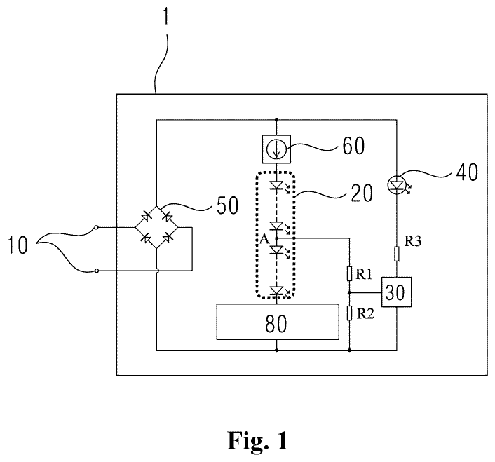

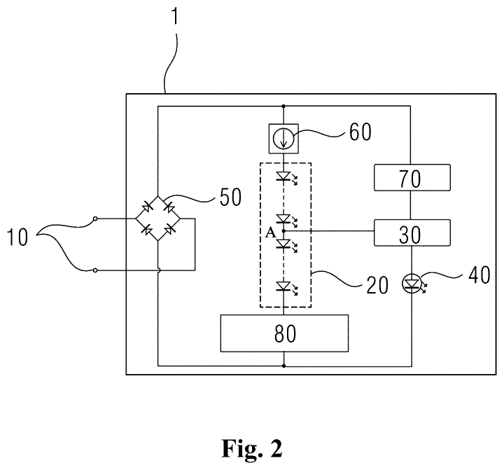

FIG. 1 is a schematic diagram showing the use of a sensing element to control an indicator diode. FIG. 2 is a schematic diagram of using a microcontroller unit to control an indicator diode.

As shown in FIG. 1 or FIG. 2, an external power source 10 is electrically connected to a lighting device 1 by wires to supply electric energy to the lighting device 1. The types of the power source 10 may comprise a renewable energy, a portable power source, etc., which is not limited in the present disclosure.

The lighting device 1 comprises a lighting diode 20, a sampling and control unit 30, an indicator diode 40, a bridge rectifier 50, and a lighting diode driver 60. In addition, the lighting device 1 may further comprise a microcontroller unit driver 70 and the like.

The bridge rectifier 50 is connected between the external power source 10 and the lighting diode 20, and rectifies an alternating current of the external power source 10 into a direct current. The bridge rectifier 50 is composed of four diodes, and can rectify an alternating current into a direct current.

The lighting diode driver 60 is connected between the external power source 10 and the lighting diode 20, for example, can serve as a constant-current source, such that the current flowing through the lighting diode 20 is constant, thereby avoiding the occurrence of unstable operation or damage to the lamp due to voltage fluctuations or other external factors.

The microcontroller unit driver 70 is connected between the external power source 10 and the sampling and control unit 30 as a microcontroller unit, and converts a voltage from the external power source 10 to drive the microcontroller unit 30, thereby satisfying the requirements of the microcontroller unit.

The lighting diode 20 has a rated lighting lifespan, for example, 10,000 to 50,000 hours, and the lighting diode 20 is connected to the external power source 10 by the driver to receive electric energy from the external power source 10 and emit light.

The lighting diode 20 can convert electric energy into light energy. The lighting diode 20 has advantages of high efficiency, long lifespan, low energy consumption, etc., and is thus widely applied in the field of lighting. Common lighting diodes comprise LEDs (Light-Emitting Diodes), etc.

The lighting diodes 20 can emit light of various colors, such as red, green and blue, and can mix light of different colors according to requirements, thereby realizing a rich and colorful lighting effect.

Generally, after an accumulated lighting duration of the lighting diode 20 reaches a rated lighting duration, the lighting diode 20 can still emit light continuously, but the emitted light is weakened, the lighting quality is deteriorated, and safety risks such as smoke or fire may occur.

In addition, when the accumulated lighting duration of the lighting diode 20 is long, deterioration of lighting quality, such as color shift, brightness decrease, and voltage increase may occur in the lighting diode 20.

In order to prevent the degradation of the lighting quality from further affecting the user, and in order to avoid potential safety issues, in the present disclosure, according to the characteristic that the voltage of the lighting diode 20 becomes larger over time, the sampling and control unit can sample the voltage across two ends of the lighting diode 20 continuously or at a predetermined sampling frequency, and when the sampled voltage reaches a preset value received from the outside, a plurality of alert manners are used to send an alert to the user. It should be noted that the sampling and control unit not only samples the voltage across two ends of the lighting diode 20, but also samples a total voltage of the lighting diode 20 and devices connected in series with the lighting diode 20 in the circuit; the devices may be a resistor or a diode as introduced hereinafter.

It should be noted that the preset value may be a value received from the outside, and may also be a sampling value obtained when the sampling and control unit 30 first samples the voltage, i.e. an initial sampling value.

In FIG. 1, the lighting diode 20 is connected to the external power source 10 by the driver to receive electric energy from the external power source and emit light; the sampling and control unit 30 is connected in parallel with the lighting diode 20, and the sampling and control unit comprises: a sampling end for sampling the voltage of the lighting diode or a specific device in the circuit when the lighting diode receives electric energy and emits light, a comparator for comparing the sampled voltage with a preset value, and an output end for sending a control signal; and the indicator diode 40 is located on a parallel branch where the sampling and control unit 30 is located, and is used for receiving the control signal; wherein when the sampled voltage is greater than the preset value, the output end of the sampling and control unit 30 sends a control signal to the indicator diode 40 or the driver of the lighting diode 20, and the control signal controls the circuit state of the indicator diode 40 to change, or the lighting diode driver controls the lighting diode 20 to flicker or darken.

The driver may be the lighting diode driver 60, or another diode driver different from the lighting diode driver 60.

In FIG. 1, the sampling and control unit 30 is a sensing element, which senses in real time the voltage of the lighting diode. In practical applications, the sensing element is an integrated element, specifically a TL431 element or similar elements. The sensing element is integrated with an amplifier and a triode; wherein the amplifier receives the voltage of the lighting diode at point A, and compares the voltage with a reference voltage, and when the voltage of the lighting diode 20 is greater than the reference voltage, the triode is turned on, and thus the circuit state of the indicator diode 40 connected in series with the sensing element changes, such that the indicator diode 40 plays the role of indication.

Since the sensing element is an existing integrated element, the sensing element will not be described in detail in the present disclosure, so as to avoid obscuring the gist of the present disclosure.

Further, the circuit state of the indicator diode 40 is not only limited to change from an off state to an on state, but also changes from an on state to an off state.

For example, in an initial state, the indicator diode 40 is in an off state and does not emit light, and the sampling and control unit 30 compares the sampled voltage of the lighting diode 20 with the preset value; and when the sampled voltage is greater than the preset value, the sampling and control unit 30 sends a control signal to the indicator diode 40, the control signal controls the indicator diode 40 to turn on and emit light, such that the current lifespan condition of the lighting diode 20 is indicated to the user by the turning on of the indicator diode 40.

For example, in the initial state, the indicator diode 40 is in an on state and emits light, and the sampling and control unit 30 compares the sampled voltage of the lighting diode 20 with the preset value; and when the sampled voltage is greater than the preset value, the sampling and control unit 30 sends a control signal to the indicator diode 40, the control signal controls brightness change of the indicator diode 40, such that the current lifespan condition of the lighting diode 20 is indicated to the user by the brightness change of the indicator diode 40.

To further strengthen the protection of the sensing element, the lighting device 1 further comprises a current-limiting resistor R3 connected in series with the sensing element to limit the current flowing through the sensing element so as to protect the sensing element. The purpose of the current-limiting resistor is to limit the current flowing through the sensing element, so as to prevent the sensing element from being damaged due to overload. The resistance value of the current-limiting resistor can be selected according to the rated current and operating voltage of the sensing element, so as to ensure that the sensing element will not be overloaded under normal operating conditions.

In addition, the lighting device 1 further comprises voltage-dividing resistors R1 and R2, and the voltage-dividing resistors are connected in parallel with the sensing element. The voltage-dividing resistors are usually each designed as a resistor with a fixed resistance value, and the purpose thereof is to convert the voltage of the lighting diode into a suitable voltage that can be accepted by the sensing element. In this way, the sensing element can be effectively protected from being damaged by an excessive voltage, and malfunction can be prevented. Specifically, the resistor R1 is connected to the point A, the resistor R2 is connected between the resistor R1 and the ground, and the sensing element 30 is connected in parallel with the resistor R2. The point A is selected by the user according to situations.

As shown in FIG. 2, as another implementation, the sampling and control unit 30 may be a microcontroller unit (MCU), the microcontroller unit is configured to sample the voltage of the lighting diode 20 at a predetermined sampling frequency; and when the sampled voltage is greater than the preset value, a processor of the microcontroller unit sends a control signal to the indicator diode 40 to control the circuit state of the indicator diode 40 to change.

The microcontroller unit (MCU) comprises a processor, a memory and an oscillator. After the microcontroller unit receives electric energy, the oscillator generates a stable clock signal, the processor performs operations such as calculation and logic determination according to instructions in a program, and the memory is used to store program codes, data and intermediate results. The processor, the memory, and the oscillator in the microcontroller unit work together to implement a control function.

In FIGS. 1 and 2, the lighting device 1 also comprises a voltage regulation device 80 connected between the lighting diode 20 and the ground. When the lighting duration of the lighting diode reaches the rated lifespan duration, the voltage of the voltage regulation device 80 changes.

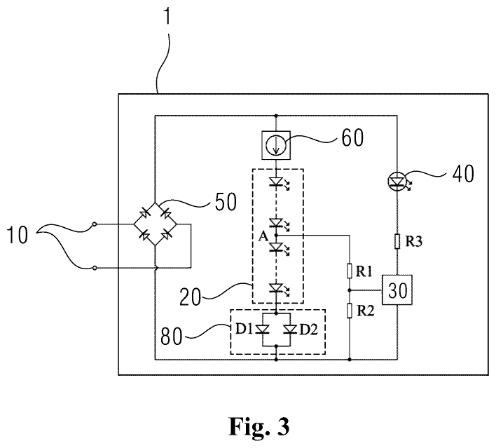

The voltage regulation device 80 can be realized in various ways. In one example, as shown in FIG. 3, the voltage regulation device 80 comprises a first diode D1 connected between the lighting diode and the ground, and a second diode D2 connected in parallel with the first diode. The first diode D1 is a silicon tube made of a silicon material, and the second diode D2 is a germanium tube made of a germanium material.

The first diode D1 has a first forward voltage drop, for example 0.7 V, and the second diode D2 has a second forward voltage drop, for example 0.3 V, which is less than the first forward voltage drop. When both the first diode D1 and the second diode D2 are turned on, the voltage across two ends of the first diode D1 is 0.3 V; and when the turn-on duration of the second diode D2 reaches the rated lighting duration (for example, 20,000 hours) of the lighting diode 20 and the second diode is turned off, the voltage across two ends of the first diode D1 becomes 0.7 V. Thus, the voltage across two ends of the first diode D1 increases, and the sampling and control unit (comprising the sensing element and the microcontroller unit) can sample or sense an obvious voltage increase, such that the measured voltage value is more accurate, and the monitoring of deterioration of lighting quality of the lighting diode 20 is more accurate.

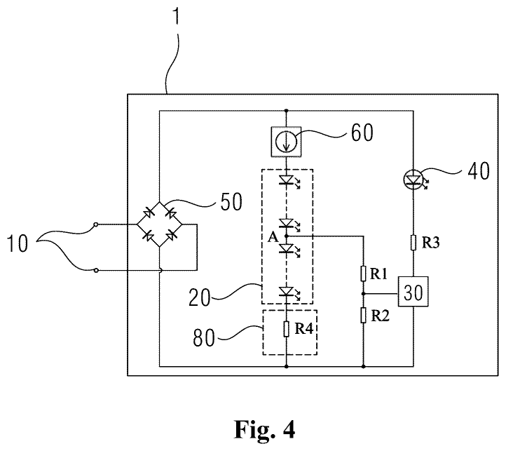

As another example, as shown in FIG. 4, the voltage regulation device 80 is a resistor R4. When the lighting diode 20 operates normally, all current flows through the resistor R4. The resistor R4 begins to generate heat and the temperature increases, and as the lighting time increases, the resistance value of the resistor R4 increases. Since the current is constant, according to Ohm's law, V=I×R, the voltage across two ends of the resistor R4 also increases gradually.

By the same reasoning, the sampling and control unit 30 (comprising the sensing element and the microcontroller unit) can sample or sense an obvious voltage increase, such that the measured voltage value is more accurate, and the monitoring of deterioration of lighting quality of the lighting diode 20 is more accurate.

As another implementation, in the present disclosure, in cases where the indicator diode 40 is not needed as an indicator, the sampling and control unit 30 can send a control signal to the diode driver 60 and directly control change of the light-emitting state of the lighting diode 20, thereby prompting a user that the lighting quality deteriorates. It should be noted that the sampling and control unit 30 may also be a microcontroller unit or a sensing element.

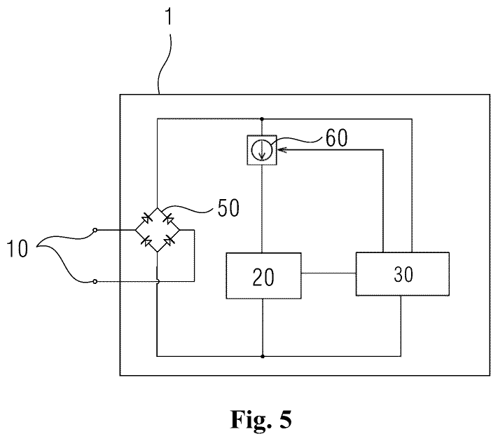

As shown in FIG. 5, in cases where the lighting device 1 is not provided with the indicator diode 40, the sampling and control unit 30 is a microcontroller unit, and a processor of the microcontroller unit samples the voltage at a selection point A of the lighting diode 20, and compares the sampled voltage with a preset value. When the sampled voltage is greater than the preset value, the processor of the microcontroller unit is in communication connection with the lighting diode driver 60 to send a control signal to the lighting diode driver so as to control the lighting diode 20 to flicker or darken. The user performs operations such as detection, maintenance, or replacement on the lighting diode 20 in time according to the change in the light-emitting state of flickering or darkening of the lighting diode 20.

In this case, the lighting device 1 can further comprise a voltage regulation device 80 connected between the lighting diode and the ground; wherein when the lighting duration of the lighting diode reaches the rated lifespan duration, the voltage of the voltage regulation device changes. The specific function of the voltage regulation device 80 is as described above.

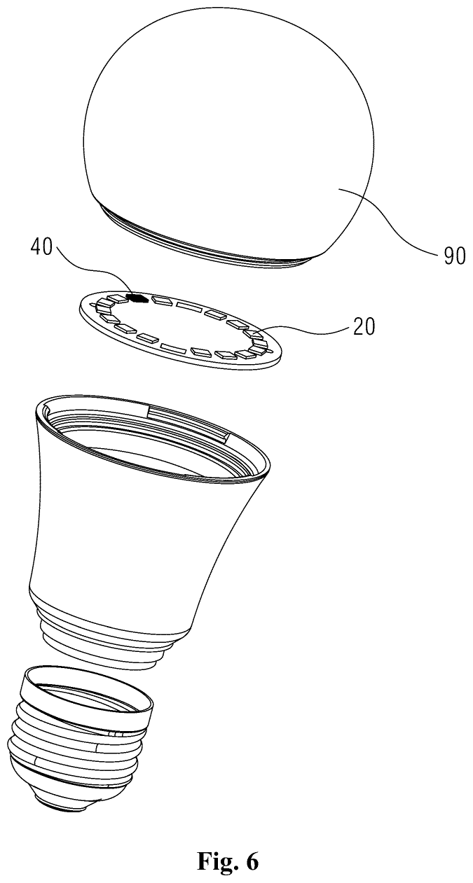

In addition, as shown in FIG. 6, the lighting device 1 may be an LED bulb, the lighting diode 1 is located inside a bulb housing 90 of the bulb, and the indicator diode 40 is located near the bulb housing 90 of the bulb. A plurality of diodes are placed on a circuit board of the bulb; and wherein one of the diodes is arranged as the indicator diode 40, and the remaining diodes are lighting diodes 20. The portion of the bulb housing 90 near the indicator diode 40 is transparent, such that the state of the indicator diode 40 can be observed. For example, a worker can visually see from the outside of the bulb whether the indication diode 40 is turned on.

The present disclosure can prompt the user of safety risks and deterioration of lighting quality at the end of life of the lamp only by means of the structure of the lamp itself without the aid of an additional device, thereby avoiding the eye fatigue of the user.

In embodiments of the present disclosure, technical solutions in which the sampling and control unit controls the circuit state of the indicator, or directly controls the light-emitting state of the lighting diode by determining a comparison between the sampled voltage of the lighting diode and the preset value are provided, so as to at least solve the technical problems of deteriorated lighting quality, potential safety risks, and poor user experience in the prior art, and achieve the technical effects of avoiding potential safety risks of the lighting device and avoiding the eye fatigue of the user.

In the embodiments of the present disclosure, the illustration of each embodiment has its own emphasis. For the part not detailed in a certain embodiment, please refer to the relevant illustration in other embodiments.

In the several embodiments provided in the present disclosure, it should be understood that the disclosed technical content may be implemented in other manners.

The content above only relates to preferred embodiments of the present disclosure. It should be noted that for a person of ordinary skill in the art, several improvements and modifications can also be made without departing from the principle of the present disclosure, and these improvements and modifications shall also be considered as within the scope of protection of the present disclosure.

1. A lighting device capable of monitoring the lighting quality thereof, the lighting device comprising:
a lighting diode, connected to an external power source by a driver to receive electric energy from the external power source and emit light;
a sampling and control unit, connected to the lighting diode, the sampling and control unit comprising: a sampling end for sampling the voltage of a specific device in a circuit when the lighting diode receives electric energy and emits light, and an output end for making a determination according to the sampled voltage and sending a control signal; and
an indicator diode, located on a branch where the sampling and control unit is located, and used for receiving the control signal,
wherein when a comparison result between the sampled voltage and a preset value changes, the output end of the sampling and control unit sends a control signal to the indicator diode, and the control signal controls the circuit state of the indicator diode to change.

2. The lighting device according to claim 1, wherein the circuit state of the indicator diode can be changed from an on state to an off state, or from an off state to an on-state.

3. The lighting device according to claim 1, wherein the sampling and control unit is a sensing element, which senses in real time the voltage of the lighting diode; and
when the comparison result between the sampled voltage and the preset value changes, the sampling and control unit controls, via the control signal, the circuit state of the indicator diode to change.

4. The lighting device according to claim 1, wherein the sampling and control unit is a microcontroller unit, which samples the voltage of the lighting diode at a predetermined sampling frequency; and when the comparison result between the sampled voltage and the preset value changes, the sampling and control unit controls the circuit state of the indicator diode to change.

5. The lighting device according to claim 3, wherein the lighting device further comprises a voltage regulation device connected between the lighting diode and the ground; wherein when the lighting duration of the lighting diode reaches a rated lifespan duration, the voltage of the voltage regulation device changes.

6. The lighting device according to claim 5, wherein the voltage regulation device comprises a first diode connected between the lighting diode and the ground, and a second diode connected in parallel with the first diode,
wherein the first diode has a first forward voltage drop, and the second diode has a second forward voltage drop less than the first forward voltage drop, and
when the turn-on duration of the second diode reaches the rated lighting duration of the lighting diode and the second diode is turned off, the voltage across two ends of the first diode increases.

7. The lighting device according to claim 5, wherein the voltage regulation device is a resistor.

8. The lighting device according to claim 6, wherein the first diode is a silicon tube, and the second diode is a germanium tube.

9. The lighting device according to claim 1, wherein the lighting device further comprises a bridge rectifier connected between the external power source and the lighting diode, the bridge rectifier rectifying an alternating current of the external power source to a direct current.

10. The lighting device according to claim 1, wherein the lighting device further comprises a lighting diode driver connected between a positive electrode of the external power source and a positive electrode of the lighting diode; and the lighting diode driver converts electric energy from the external power source, such that the current flowing through the lighting diode is constant.

11. The lighting device according to claim 1, wherein when the sampling and control unit is a microcontroller unit, the lighting device further comprises a microcontroller unit driver connected between a positive electrode of the external power source and the microcontroller unit, and the microcontroller unit driver converts a voltage from the external power source to drive the microcontroller unit.

12. The lighting device according to claim 1, wherein the sampling and control unit comprises a voltage comparator, which is connected to the sampling end and the output end; wherein the voltage comparator compares the sampled voltage with the preset value and outputs a comparison result from the output end.

13. The lighting device according to claim 1, wherein the lighting diode comprises a red diode emitting red light, a green diode emitting green light, or a blue diode emitting blue light.

14. The lighting device according to claim 1, wherein the preset value is a value input from the outside or an initial value sampled by the sampling and control unit.

15. A lighting device capable of monitoring the lighting quality thereof, the lighting device comprising:
a lighting diode, connected to an external power source by a driver to receive electric energy from the external power source and emit light; and
a sampling and control unit, connected to the lighting diode, the sampling and control unit comprising: a sampling end for sampling the voltage of a specific device in a circuit when the lighting diode receives electric energy and emits light, and an output end for making a determination according to the sampled voltage and sending a control signal,
wherein when a comparison result between the sampled voltage and a preset value changes, the output end of the sampling and control unit sends the control signal to the driver, and the driver changes the light-emitting state of the lighting diode according to the control signal.

16. The lighting device according to claim 15, wherein the sampling and control unit is a sensing element, which senses in real time the voltage of the lighting diode; and when the comparison result between the sampled voltage and the preset value changes, the sampling and control unit controls, via the control signal, the light-emitting state of the lighting diode to change.

17. The lighting device according to claim 15, wherein the sampling and control unit is a microcontroller unit, which samples the voltage of the lighting diode at a predetermined sampling frequency; and when the comparison result between the sampled voltage and the preset value changes, the sampling and control unit controls, via the control signal, the light-emitting state of the lighting diode to change.

18. The lighting device according to claim 16, wherein the lighting device further comprises a voltage regulation device connected between the lighting diode and the ground, wherein when the lighting duration of the lighting diode reaches a rated lifespan duration, the voltage of the voltage regulation device changes.

19. The lighting device according to claim 16, wherein the sampling and control unit comprises a voltage comparator, wherein the voltage comparator is connected to the sampling end and the output end; wherein the voltage comparator compares the sampled voltage with the preset value and outputs a comparison result from the output end.

20. The lighting device according to claim 15, wherein the light-emitting state of the lighting diode changes to be flickering or darkening.

21. A lighting device capable of monitoring the lighting quality thereof, the lighting device comprising:
a lighting diode, connected to an external power source by a driver to receive electric energy from the external power source and emit light;
a sampling and control unit, connected to the lighting diode, the sampling and control unit comprising: a sampling end for sampling the voltage of a specific device in a circuit when the lighting diode receives electric energy and emits light, and an output end for making a determination according to the sampled voltage and sending a control signal; and
an indicator, located on a branch where the sampling and control unit is located, and used for receiving the control signal,
wherein when a comparison result between the sampled voltage and a preset value changes, the output end of the sampling and control unit sends a control signal to the indicator, and the control signal controls the circuit state of the indicator to change.
